(19) United States
(12) Patent Application Publication
(10) Pub. No.: US 2026/0043934 A1
(43) Pub. Date: Feb. 12, 2026

(54) METHOD FOR GRIDDING AND DENOISING OF GEOPHYSICAL POTENTIAL FIELD DATA

(71) Applicant: NORTHEASTERN UNIVERSITY, Shenyang (CN)

(72) Inventors: Zhenlong HOU, Shenyang (CN); Jinrong SHEN, Shenyang (CN); Xingdong ZHAO, Shenyang (CN); Jikang WEI, Shenyang (CN)

(21) Appl. No.: 19/279,646

(22) Filed: Jul. 24, 2025

(30) Foreign Application Priority Data
Aug. 6, 2024 (CN) 202411069155.0

(51) Int. Cl. G01V 3/38; G01V 3/08; G01V 20/00

(52) U.S. Cl. CPC G01V 3/38; G01V 3/08; G01V 20/00

(57) ABSTRACT

A method for gridding and denoising of geophysical potential field data includes: first, establishing an original geophysical potential field data and a noisy data set of a geophysical potential field; inputting specified original geophysical potential field data into a diffusion model for training to obtain a qualified diffusion model; second, obtaining a number of denoising steps corresponding to the noisy data set, and training a noise level selection network by using the number of denoising steps together with the noisy data set; then, determining positions of scattered point data according to coordinates and anomalies of the geophysical potential field data to be processed, and assigning the anomalies at corresponding positions to generate the scattered point data; and finally, gridding the scattered point data by using the diffusion model, and denoising the gridded data by using a noise level selection network model in combination with the diffusion model.

### FIELD OF THE INVENTION

The present invention relates to the technical field of gravity and magnetic exploration data processing and, in particular, to a method for gridding and denoising of geophysical potential field data.

### THE PRIOR ARTS

Limited by the influence of factors such as the topography of a data collection area, survey points, and survey line division, the spatial position distribution of the collected geophysical potential field data is often irregular. Moreover, affected by measuring instruments, geological environment and other factors, the collected data often contains certain noise. During the data processing process, the collected data generally needs to be gridded, and denoising helps improve the accuracy of data interpretation. Therefore, gridding and denoising of potential field data are one of the indispensable steps in data processing. By means of gridding and denoising, it lays the foundation for high-precision potential field data interpretation.

At present, both conventional numerical computation methods and equivalent source methods have the problem of low gridding accuracy. In recent years, the rapid development of artificial intelligence (AI) technology has provided new ideas for solving the above problems. Many scholars have carried out a lot of research on AI-based gridding methods of geophysical potential field data: LI An et al. used a neural network based on the Bagging algorithm to interpolate the background field of ocean gravity anomalies based on satellite altimetry, which improved the adaptive accuracy of the matching algorithm and the navigation accuracy. LIU Huan et al. also provided a recursive neural network reconstruction algorithm based on long-short-term memory networks in view of three machine learning models: support vector machine, random forest algorithm and gradient enhancement. Compared with traditional linear methods, it achieved good reconstruction effect. Similarly, in terms of denoising of geophysical potential field data, LIN Fanqiang et al. used deep learning methods to solve the problem of poor denoising effect when there is a huge difference between the noise distribution of transient electromagnetic data signals and the noise distribution of synthetic data sets. LI Jin et al. used a combination method of long-short-term memory networks and convolutional neural networks to denoise data containing strong noise, proving that its denoising effect was better than that of a feature parameter classification method.

The above researches show that AI has shown great potential in gridding and denoising geophysical potential field data, and has achieved good results. Compared with traditional methods, intelligent methods can retain and restore geophysical data characteristics more completely. Therefore, carrying out research on intelligent potential field data gridding and denoising methods can provide technical support for future high-precision data processing and interpretation.

### SUMMARY OF THE INVENTION

In view of the described shortcomings in the prior art, the technical problem to be solved by the present invention is to provide a method for gridding and denoising of geophysical potential field data to achieve gridding and denoising of geophysical potential field data.

To solve the above technical problems, the present invention provides the following technical solutions: A method for gridding and denoising of geophysical potential field data comprises the following steps:
step 1: generating geophysical potential field data by means of stochastic forward modelling, and adding noise to generate a noisy data set of a geophysical potential field;
step 1.1: generating an original geophysical potential field data set by means of stochastic forward modelling, wherein
the stochastic forward modelling is carried out to stochastically generate a cuboid model with different scales, different shapes, different positions, different densities and different magnetic susceptibility in a determined survey area space, and potential field anomaly data of the models is computed to form the original geophysical potential field data set,
the potential field anomaly data includes gravity anomaly data, gravity gradient data, and magnetic anomaly and magnetic gradient type data, and the original geophysical potential field data set consists of various types of potential field anomaly data, wherein each set of the potential field anomaly data denotes an anomaly generated by a certain stochastic model;
step 1.2: extracting a certain proportion of the geophysical potential field data and adding different levels of noise to generate the noisy data set of the geophysical potential field, wherein
a proportion of extracted data is at least 1% of data in the original geophysical potential field data set, an amount of data for each type is the same, an amount of different component data used and an amount of different anomaly data used are the same, and the added noise is Gaussian noise;
step 2: training a diffusion model using an original geophysical potential field data set until a qualified diffusion model is obtained;
step 2.1: normalizing the original geophysical potential field data set;
step 2.2: training the diffusion model using the normalized original geophysical potential field data set;
a computing process of the diffusion model includes a forward process and a reverse process;
step 3: computing a number of denoising steps corresponding to each noisy data set, and training a noise level selection network by using the number of denoising steps together with the noisy data set to obtain a qualified noise level selection network model;
step 3.1: calculating mean square error (MSE) values between denoised data and a noise-free original geophysical potential field data;
step 3.2: based on the MSE values between the denoised data and the noise-free original geophysical potential field data in step 3.1, obtaining the number of denoising steps corresponding to each noisy data set using the diffusion model trained in step 2, wherein
let an iteration number be k, wherein k=0, 1, 2, . . . , kₘₐₓ, kₘₐₓ denotes a maximum iteration number, the MSE value in a k-th iteration of the noisy data set is computed and recorded, wherein the MSE values decrease as the iteration number increases, and if the MSE values increase, a number of reverse-process computations is a current iteration number k minus 1, and the number of de-noising steps is k−1; and
step 3.3: inputting the number of denoising steps obtained in step 3.2 and a corresponding noisy data set into the noise level selection network for training;
normalizing the noisy data set, and using a classification network model as the noise level selection network, wherein the classification network model uses cross-entropy as a loss function;
step 4: determining positions of scattered point data according to coordinates and anomalies of the geophysical potential field data to be processed, and assigning the anomalies at corresponding positions to generate the scattered point data;
step 4.1: determining observation and survey-line spacing of the scattered point data according to the geophysical potential field data to be processed, and determining a spatial distribution range of the scattered point data; and
step 4.2: calculating a Euclidean distance between positions of geophysical potential field data points to be processed and positions of points of scattered point data, and assigning positions of designated scattered points according to the Euclidean distance; and
traversing coordinates of the geophysical potential field data points to be processed, and assigning the geophysical potential field data to be processed to corresponding positions in the scattered point data according to a corresponding minimum Euclidean distance to obtain the scattered point data, wherein the scattered point data comprises data coordinates and corresponding potential field data;
step 5: inputting the scattered point data into the diffusion model and performing data gridding on the scattered point data;
performing the reverse-process computation on the scattered point data by means of a trained diffusion model to obtain a missing data part

$${x}_{t - 1}^{l o s s}$$

in the gridded data, which obeys a normal distribution with a mathematical expectation of μ_{θ}(xₜ, t) and a variance of Σ_{θ}(xₜ, t), wherein the missing data part is expressed as follows:

$${x}_{t - 1}^{l o s s} ∼ 𝒩 ( {μ}_{θ} ( {x}_{t} , t ) , {\sum }_{θ} ( {x}_{t} , t ) )$$

wherein μ_{θ}(xₜ, t) and Σ_{θ}(xₜ, t) are both parameters for Gaussian model distribution of the diffusion model, μ_{θ}(xₜ, t) is the mathematical expectation of the Gaussian model distribution, and Σ_{θ}(xₜ, t) is the variance of the Gaussian model distribution; and
finally obtaining the gridded data

$${x}_{t - 1}^{final}$$

of the geophysical potential field data to be processed, wherein the gridded data is expressed as:

$${x}_{t - 1}^{final} = {x}_{t - 1}^{l o s s} + {x}_{t - 1}^{o r i}$$

wherein

$$x {}_{t - 1}^{ori}$$

denotes the scattered point data, and

$${x}_{t - 1}^{final}$$

step 6: inputting the gridded data into the noise level selection network, calculating a required number of denoising steps, and performing denoising in combination with the diffusion model;
step 6.1: calculating the number of denoising steps by means of the noise level selection network;
wherein the gridded data

$${x}_{t}^{final}$$

generated in step 5 is input into the noise level selection network, noises contained in the gridded data are classified by the noise level selection network, and a required number k of denoising steps is calculated; and
step 6.2: performing denoising computation on the gridded data using the diffusion model in combination with the number of denoising steps obtained in step 6.1;
wherein the gridded data

$${x}_{t}^{final}$$

and the corresponding required number k of denoising steps are input into the diffusion model for denoising, and the computing process for denoising

$${x}_{t}^{final}$$

is as follows: first, calculating the iteration number step-value required for traversing, wherein the values of the step-value are k, k−1, . . . , 1; and then performing step, step-1, . . . , 1, 0 reverse processes on the gridded data according to different iteration number step-values to obtain the denoised data.

The beneficial effects achieved by the technical solutions described above are as follows: In the method for gridding and denoising of geophysical potential field data, the Euclidean distance is used to redefine and generate scattered point data. In this way, the utilization of known data and the retention of the characteristics of the data to be processed can be maximized. Use of the diffusion model can achieve accurate reconstruction of missing data. Use of the noise level network can achieve better denoising results. It has been verified that the MSE value obtained after the geophysical potential field data generated by the synthetic model is gridded and denoised by the method of the present invention is at least 0.1457. It can solve the problem of low accuracy of the noisy data set of the geophysical potential field after gridding. Compared with other methods, the method of the present invention has the advantages of high accuracy and high robustness, and is suitable for gridding and denoising of measured geophysical potential field data. The method of the present invention is of great significance for improving the processing and interpretation accuracy of the geophysical potential field data.

### BRIEF DESCRIPTION OF THE DRAWINGS

FIG. 1 is a flowchart of a method for gridding and denoising of geophysical potential field data according to an embodiment of the present invention.

FIG. 2 shows synthetic model positions and raw data about gravity gradient V_{zz} according to an embodiment of the present invention: (a) synthetic model position diagram, and (b) gravity gradient V_{zz} data image.

FIG. 3 shows scattered point data generated from geophysical potential field data to be processed and a final gridded image according to an embodiment of the present invention: (a) scattered point data after computing, and (b) gridded V_{zz} data image.

FIG. 4 shows scattered point data measured in the Vinton Salt-Dome are according to an embodiment of the present invention: (a) gravity gradient data Vₓₓ, (b) gravity gradient data V_{xy}, (c) gravity gradient data V_{xz}, (d) gravity gradient data V_{yy}, (e) gravity gradient data V_{yz}, (f) gravity anomaly data V_{z}, and (g) gravity gradient data V_{zz}.

FIG. 5 shows data measured in the Vinton Salt-Dome area after denoising according to an embodiment of the present invention: (a) denoised gravity gradient data Vₓₓ, (b) denoised gravity gradient data V_{xy}, (c) denoised gravity gradient data V_{xz}, (d) denoised gravity gradient data V_{yy}, (e) denoised gravity gradient data V_{yz}, (f) denoised gravity anomaly data V_{z}, and (g) gravity gradient data V_{zz}.

### DETAILED DESCRIPTION OF THE EMBODIMENTS

Specific embodiments of the present invention will be described in further detail below with reference to the drawings and embodiments. The following embodiments are described to illustrate the present invention but should not be construed as limiting the scope of the invention.

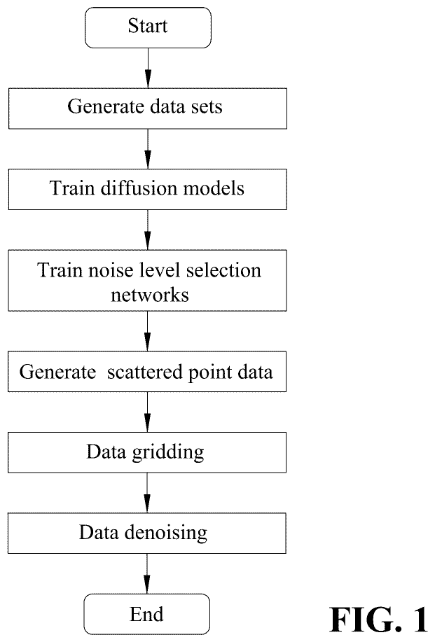

In an embodiment, a method for gridding and denoising of geophysical potential field data, as shown in FIG. 1, comprises the following steps.

Step 1: generating geophysical potential field data by means of stochastic forward modelling, and adding noise to generate a noisy data set of a geophysical potential field.

Step 1.1: generating an original geophysical potential field data set by means of stochastic forward modelling, wherein
the stochastic forward modelling is carried out to stochastically generate a cuboid model with different scales, different shapes, different positions, different densities and different magnetic susceptibility in a determined survey area space, and potential field anomaly data of the models is computed to form the original geophysical potential field data set,
the potential field anomaly data includes gravity anomaly data, gravity gradient data, and magnetic anomaly and magnetic gradient type data, and the original geophysical potential field data set consists of various types of potential field anomaly data, wherein each set of the potential field anomaly data denotes an anomaly generated by a certain stochastic model.

In this embodiment, the forward modelling used is performed under a Cartesian coordinate system, and the forward modelling method used is stochastic distributed cuboid forward modelling, so that cuboids with stochastic positions, stochastic sizes, stochastic residual densities and stochastic magnetization intensity were generated and distributed in a survey area. The generated data has a distribution range of 0 m to 6400 m, 0 m to 6400 m, and 0 m to 1000 m on x, y, and z axes, respectively. Observation and survey-line spacing are both 50 m. The values of gravity anomaly data V_{z}, gravity gradient data Vₓₓ, V_{xy}, V_{xz}, V_{yy}, V_{yz}, V_{zz} and total field magnetic anomaly ΔT are calculated for the established cuboid synthetic models respectively. The data set used contains 10⁵ sets of data.

Step 1.2: extracting a certain proportion of the geophysical potential field data and adding different levels of noise to generate the noisy data set of the geophysical potential field.

In terms of an amount of extracted data, a proportion of extracted data is at least 1% of data in the original geophysical potential field data set, an amount of data for each type is the same, an amount of different component data used and an amount of different anomaly data used are the same, and the added noise is Gaussian noise. The addition of the noise is expressed as:

$${X}_{n} = X + {X}_{max} \times 𝒩 ( 0 , 1 ) \times Noiselevel \qquad ( 1 )$$

wherein Xₙ is a noised data matrix, X is an original data matrix, Xₘₐₓ is a maximum value of the original data matrix, [symbol] (0,1) denotes obeying a normal distribution with a mathematical expectation of 0 and a variance of 1, and Noiselevel denotes a level of noise, which is a percentage. Noiselevel here refers to a percentage of the maximum values of different original data matrices.

In this embodiment, in order to cover as many noise types as possible, 1000 samples are extracted from each type of data and Gaussian noises corresponding to 1%, 3%, 5% and 7% of the maximum data values are added respectively.

Step 2: training a diffusion model using the original geophysical potential field data set until a qualified diffusion model is obtained.

Step 2.1: normalizing the original geophysical potential field data set, wherein the data normalizing is expressed as follows:

$${x}_{scale} = \frac{x - {x}_{min}}{{x}_{max} - {x}_{min}} \qquad ( 2 )$$

wherein Xₘₐₓ and Xₘᵢₙ denote the maximum and minimum values of the data to be normalized respectively, x denotes the value before normalization, and x_{scale} denotes the value after normalization.

Step 2.2: training the diffusion model using the normalized original geophysical potential field data set,
wherein a computing process of the diffusion model includes a forward process and a reverse process, wherein the forward process is expressed as follows:

$$q ( {x}_{t} \vert {x}_{t - 1} ) = 𝒩 ( {x}_{t} ; \sqrt{1 - {β}_{t}} {x}_{t - 1} , {β}_{t} I ) \qquad ( 3 )$$

wherein q(xₜ|xₜ₋₁) denotes a probability distribution of xₜ under a condition of xₜ₋₁, I is a unit matrix, t is a number of steps, xₜ denotes a value of an input data after t times of noising,

$${\{ {β}_{t} \}}_{t}^{T} = 1$$

is a variance used for each step, T is a total number of training steps, βt is positively correlated with the number t of steps in the forward process, [symbol] (xₜ; \sqrt{1−βₜ}xₜ₋₁, βₜI) denotes that the input data xₜ obeys a normal distribution with a mathematical expectation of \sqrt{1−βₜ}xₜ₋₁ and a variance of βₜI, and the reverse process is expressed as follows:

$${p}_{θ} ( {x}_{t - 1} \vert {x}_{t} ) = 𝒩 ( {x}_{t - 1} ; {μ}_{θ} ( {x}_{t} , t ) , {\sum }_{θ} ( {x}_{t} , t ) ) \qquad ( 4 )$$

wherein p_{θ}(xₜ₋₁|xₜ) denotes a probability distribution of xₜ₋₁ under a condition ofθand xₜ, μ_{θ}(xₜ, t) and Σ_{θ}(xₜ, t) are parameters obtained by network training (the number of training times ≥50,000), μ_{θ}(xₜ, t) is a mathematical expectation of a Gaussian model distribution, Σ_{θ}(xₜ, t) is a variance of the Gaussian model distribution, and [symbol] (xₜ₋₁; μ_{θ}(xₜ, t), Σ_{θ}(xₜ, t)) denotes that the input dataxₜ₋₁ obeys a normal distribution with a mathematical expectation of μ_{θ}(xₜ, t) and a variance of Σ_{θ}(xₜ, t).

In this embodiment, in order to ensure that the diffusion model used is adequately trained, 60,000 times of training are performed using the normalized original geophysical potential field data set.

Step 3: computing a number of denoising steps corresponding to each noisy data set, and training a noise level selection network by using the number of denoising steps together with the noisy data set to obtain a qualified noise level selection network model.

Step 3.1: calculating mean square error (MSE) values between denoised data and a noise-free original geophysical potential field data according to the following equation:

$$MSE = m - 1 {\sum }_{i = 1}^{m} {( {x}_{i} - {g}_{i} )}^{2} \qquad ( 5 )$$

wherein m denotes an amount of noisy data set, xᵢ denotes noise-free original data, and gᵢ denotes a preliminary denoising result obtained by computations of the reverse process of the diffusion model.

Step 3.2: based on the MSE values between the denoised data and the noise-free original geophysical potential field data in step 3.1, obtaining the number of denoising steps corresponding to each noisy data set using the diffusion model trained in step 2, wherein
let an iteration number be k, wherein k=0, 1, 2, . . . , kₘₐₓ, kₘₐₓ denotes a maximum iteration number, the MSE value in a k-th iteration of the noisy data set is computed and recorded, wherein the MSE values decrease as the iteration number increases, and if the MSE values increase, a number of reverse-process computations is a current iteration number k minus 1, and the number of de-noising steps is k−1.

Step 3.3: inputting the number of denoising steps obtained in step 3.2 and a corresponding noisy data set into the noise level selection network for training;
normalizing the noisy data set, and using a classification network model as the noise level selection network, wherein the classification network model uses cross-entropy as a loss function, expressed as:

$$H ( {P}^{*} \vert P ) = - {\sum }_{i} {P}^{*} ( i ) log P ( i ) \qquad ( 6 )$$

wherein p*(i) denotes an actual target category, p(i) denotes a predicted target category, and a model with a minimum cross-entropy and the cross-entropy being less than 0.1 is selected.

In this embodiment, the noise level selection network used is ResNet 18. After at least 200 times of training in total, the minimum cross-entropy of a final model is 0.088.

Step 4: determining positions of scattered point data according to coordinates and anomalies of the geophysical potential field data to be processed, and assigning the anomalies at corresponding positions to generate the scattered point data.

Step 4.1: determining observation and survey-line spacing of the scattered point data according to the geophysical potential field data to be processed, and determining a spatial distribution range of the scattered point data;
wherein the geophysical potential field data to be processed includes measured anomalies and corresponding coordinates thereof; in order to ensure an accuracy of data reconstruction, a spatial distribution range of scattered point data needs to be determined, thereby determining a range of data after gridding (that is, a range of the geophysical potential field data to be processed is included within the survey area range of the scattered point data), and determining the observation and survey-line spacing of the scattered point data.

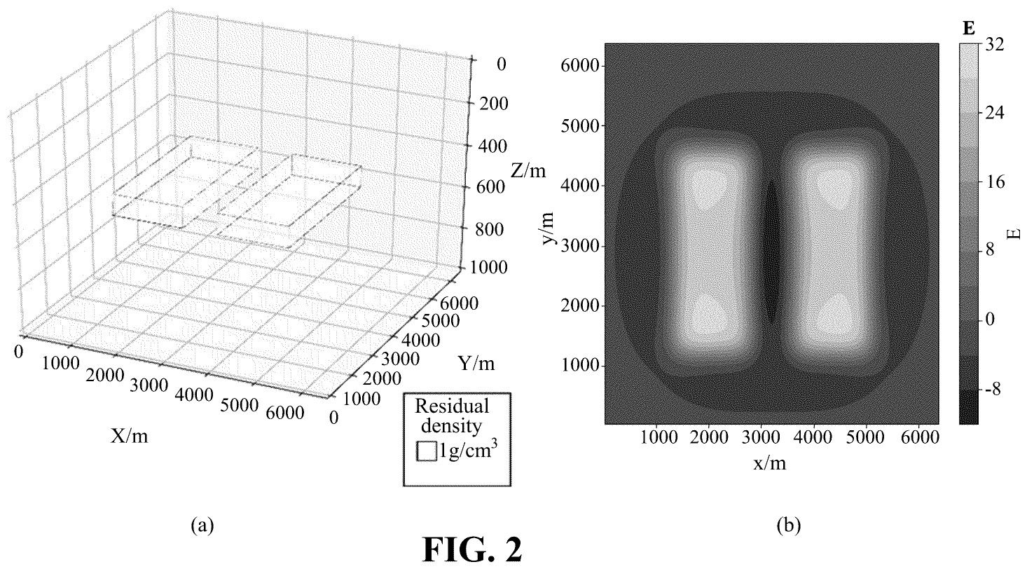

In this embodiment, during a synthetic model test, the positions of synthetic model used are shown in FIG. 2(a), which included two cuboids of equal size and the same residual density (1 g/cm³). Distribution ranges of the cuboids on x-axis are from 1325 m to 2825 m and from 3575 m to 5075 m respectively, distribution ranges on y-axis are both from 1200 m to 4600 m, and distribution ranges on z-axis are both from 400 m to 500 m. The V_{zz} data image corresponding to the models are shown in FIG. 2(b). The image is plotted under a condition that spatial distribution ranges on x, y, and z axes are from 0 m to 6400 m, from 0 m to 6400 m, and from 0 m to 1000 m, respectively, and the observation and survey-line spacing are both determined to be 50 m.

Step 4.2: calculating a Euclidean distance between positions of geophysical potential field data points to be processed and positions of points of the scattered point data, and assigning positions of designated scattered points according to the Euclidean distance, wherein
the Euclidean distance between the positions of the geophysical potential field data points to be processed and the positions of points of the scattered point data is given by:

$$D = \sqrt{{( {d}_{1} - {d}_{2} )}^{2} + {( {l}_{1} - {l}_{2} )}^{2}} \qquad ( 7 )$$

wherein D denotes the Euclidean distance between the position of a geophysical potential field data point to be processed and the positions of points of the scattered point data, dᵢ and l₁ are the coordinates of the position of the geophysical potential field data point to be processed, and d₂ and l₂ are the coordinates of the points of the scattered point data;
traversing coordinates of the geophysical potential field data points to be processed, and assigning the geophysical potential field data to be processed to corresponding positions in the scattered point data according to a corresponding minimum Euclidean distance to obtain scattered point data, wherein the scattered point data comprises data coordinates and corresponding potential field data.

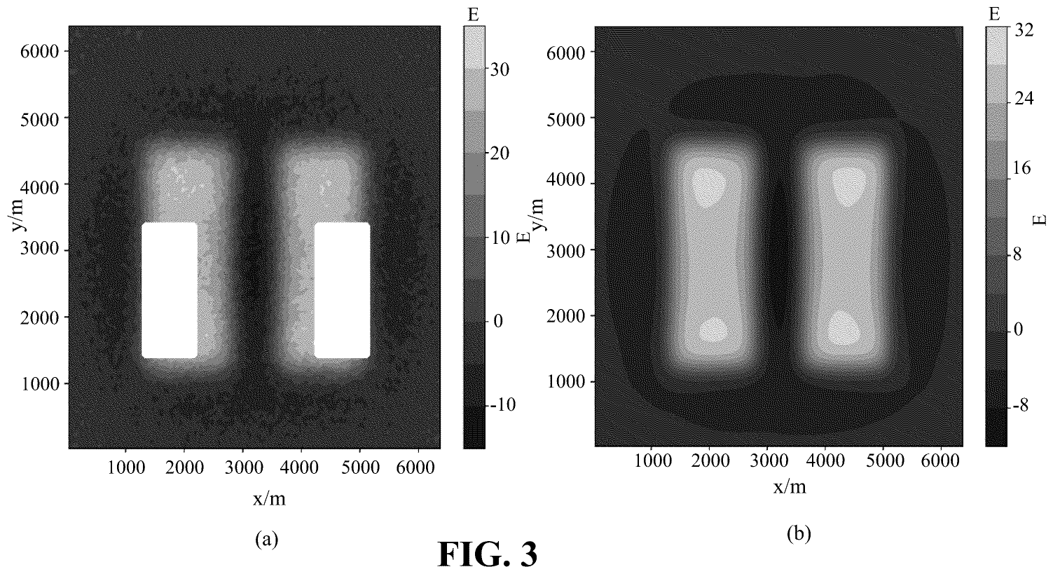

In this embodiment, during the synthetic model test, the scattered point data obtained after computation are shown in FIG. 3(a).

Step 5: inputting the scattered point data into the diffusion model and performing data gridding on the scattered point data;
performing the reverse-process computation on the scattered point data by means of a trained diffusion model to obtain a missing data part

$${x}_{{t}^{- 1}}^{loss}$$

in the gridded data, which obeys a normal distribution with a mathematical expectation of μ_{θ}(xₜ, t) and a variance of Σ_{θ}(xₜ, t), wherein the missing data part is expressed as follows:

$${x}_{{t}^{- 1}}^{l o s s} ∼ 𝒩 ( {μ}_{θ} ( {x}_{t} , t ) , {\sum }_{θ} ( {x}_{t} , t ) ) \qquad ( 8 )$$

wherein μ_{θ}(xₜ, t) and Σ_{θ}(xₜ, t) are both parameters for Gaussian model distribution of the diffusion model in step 2, μ_{θ}(xₜ, t) is the mathematical expectation of the Gaussian model distribution, and Σ_{θ}(xₜ, t) is the variance of the Gaussian model distribution; and
finally obtaining the gridded data

$${x}_{t - 1}^{final}$$

of the geophysical potential field data to be processed, wherein the gridded data is expressed as:

$${x}_{t - 1}^{final} = {x}_{t - 1}^{loss} + {x}_{t - 1}^{ori} \qquad ( 9 )$$

wherein

$${x}_{t - 1}^{ori}$$

denotes the scattered point data, and

$${x}_{t - 1}^{final}$$

denotes the gridded data.

In this embodiment, during the synthetic model test, after inputting the scattered point data in step 4.2 into the diffusion model, the gridded noisy data as shown in FIG. 3(a) can be obtained.

Step 6: inputting the gridded data into the noise level selection network, calculating a required number of denoising steps, and performing denoising in combination with the diffusion model.

Step 6.1: calculating the number of denoising steps by means of the noise level selection network;

wherein the gridded data

$${x}_{t}^{final}$$

generated in step 3 is input into the noise level selection network, noises contained in the gridded data are classified by the noise level selection network, and a required number k of denoising steps is calculated.

Step 6.2: performing denoising computation on the gridded data using the diffusion model in combination with the number of denoising steps obtained in step 6.1;

wherein the gridded data

$${x}_{t}^{fin al}$$

and the corresponding required number k of denoising steps are input into the diffusion model for denoising, and the computing process for denoising

$${x}_{t}^{final}$$

is as follows: first, calculating the iteration number step-value required for traversing, wherein the values of the step-value are k, k−1, . . . , 1; and then performing step, step-1, . . . , 1, 0 reverse processes on the gridded data according to different iteration number step-values to obtain the denoised data. The computation of the reverse process is performed according to Equation (4), which is similar to Formula (8),

$${x}_{t - 1}^{result}$$

denotes the denoised data and also

$${x}_{t - 1}^{result}$$

satisfies anormal distribution with a mathematical expectation of μ_{θ}(xₜ, t) and a variance of Σ_{θ}(xₜ, t), that is:

$${x}_{t - 1}^{result} ∼ 𝒩 ( {μ}_{θ} ( {x}_{t}^{final} , t ) , {\sum }_{θ} ( {x}_{t}^{final} , t ) ) . \qquad ( 10 )$$

In this embodiment, during the synthetic model test, the final result of denoising the gridded data using the diffusion model is shown in FIG. 3(b).

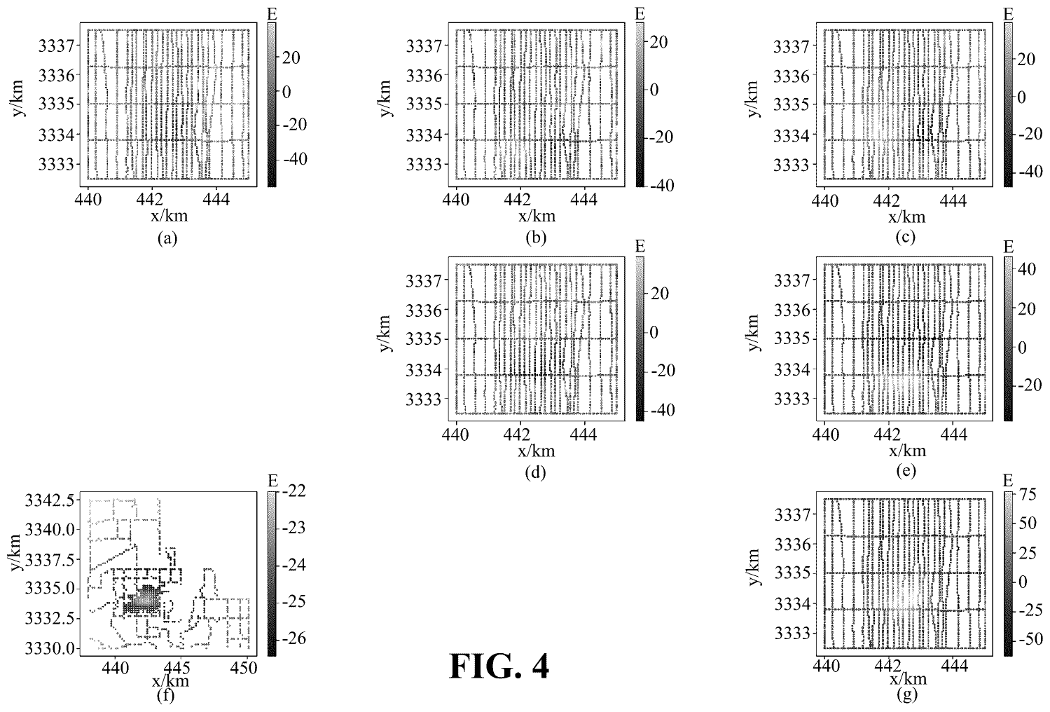

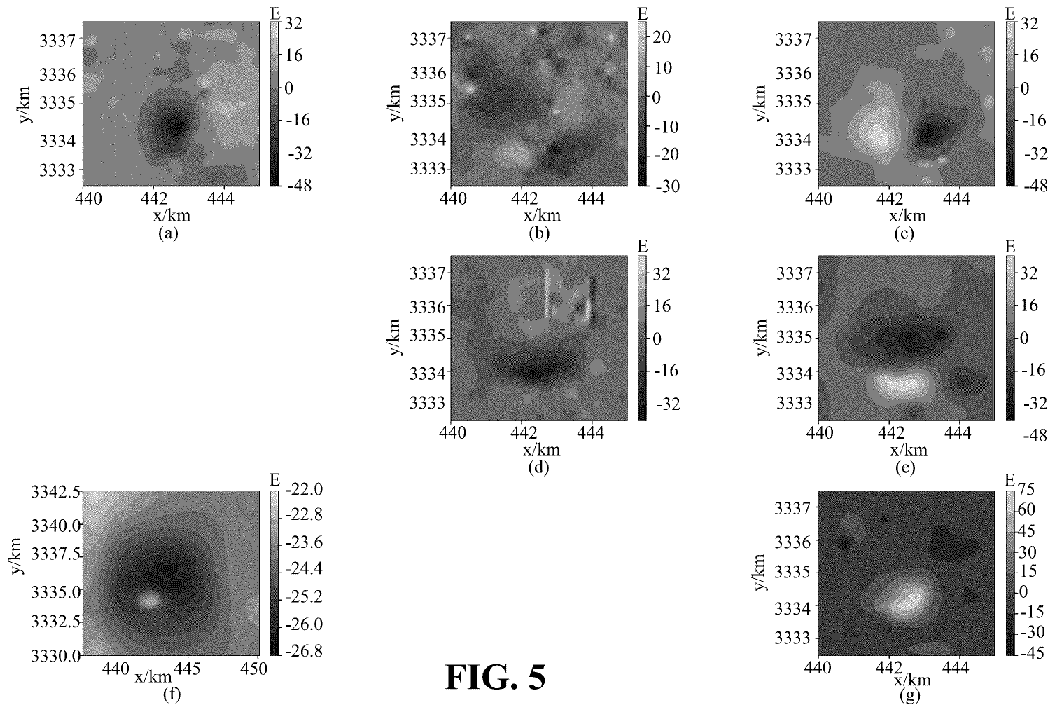

In order to verify the practicality of the method of the present invention, this embodiment also uses the measured geophysical potential field data in the Vinton Salt-Dome area of the United States for testing. The results are shown in FIGS. 4 and 5. FIG. 4 shows scattered point data after computing, and FIG. 5 shows the measured geophysical potential field data after final gridding and denoising. The ranges of the full tensor airborne gravity gradient data used here are: x: 438.504 km-450.104 km, y: 3335.584 km-3345.18 km; and the data scale is 128×128. The ranges of surface gravity anomalies used are: x: 438 km-450 km, y: 3330 km-3342.565 km, and the data scale is 80×80. By using the method of the invention, gridding and denoising of data in the Vinton Salt-Dome area are realized, the obtained final grid data has high accuracy, and the noise is suppressed. The method is beneficial to high-accuracy data processing and interpretation research.

Finally, it should be noted that the above embodiments are only used for describing the technical solutions of the present invention, but not for limitation; although the present invention has been described in detail with reference to the foregoing embodiments, those of ordinary skill in the art should understand that: they can still make modifications to the technical solutions described in the foregoing embodiments, or make equivalent replacements to some or all technical characteristics; and these modifications or replacements do not make the essence of the corresponding technical solutions deviate from the scope defined by the claims of the present invention.

1. A method for gridding and denoising of geophysical potential field data, comprising the following steps:
step 1: generating geophysical potential field data by means of stochastic forward modeling, and adding noise to generate a noisy data set of a geophysical potential field;
step 2: training a diffusion model using an original geophysical potential field data set until a qualified diffusion model is obtained;
step 3: computing a number of denoising steps corresponding to each noisy data set, and training a noise level selection network by using the number of denoising steps together with the noisy data set to obtain a qualified noise level selection network model;
step 4: determining positions of scattered point data according to coordinates and anomalies of the geophysical potential field data to be processed, and assigning the anomalies at corresponding positions to generate the scattered point data;
step 5: inputting the scattered point data into the diffusion model and performing data gridding on the scattered point data;
performing the reverse-process computations on the scattered point data by means of the trained diffusion model to obtain a missing data part
$${x}_{t - 1}^{loss}$$
in the gridded data, which obeys a normal distribution with a mathematical expectation of μ_{θ}(xₜ,t) and a variance of Σ_{θ}(xₜ, t), wherein the missing data part is expressed as follows:
$${x}_{t - 1}^{loss} ∼ 𝒩 ( {μ}_{θ} ( {x}_{t} , t ) , {\sum }_{θ} ( {x}_{t} , t ) )$$
wherein μ_{θ}(xₜ,t) and Σ_{θ}(xₜ,t) are both parameters for Gaussian model distribution of the diffusion model, μ_{θ}(xₜ,t) is the mathematical expectation of the Gaussian model distribution, and Σ_{θ}(xₜ,t) is the variance of the Gaussian model distribution; and
finally obtaining the gridded data
$${x}_{t - 1}^{final}$$
of the geophysical potential field data to be processed, wherein the gridded data is expressed as:
$${x}_{t - 1}^{final}$$
wherein
$${x}_{t - 1}^{ori}$$
denotes the scattered point data, and
$${x}_{t - 1}^{final}$$
denotes the gridded data; and
step 6: inputting the gridded data into the noise level selection network, calculating a required number of denoising steps, and performing denoising in combination with the diffusion model;
step 6.1: calculating the number of denoising steps by means of the noise level selection network,
wherein the gridded data
$${x}_{t}^{final}$$
generated in step 5 is inputted into the noise level selection network, noises contained in the gridded data are classified by the noise level selection network, and a required number k of denoising steps is calculated; and
step 6.2: performing denoising computation on the gridded data using the diffusion model in combination with the number of denoising steps obtained in step 6.1;
wherein the gridded data
$${x}_{t}^{final}$$
and the corresponding required number k of denoising steps are inputted into the diffusion model for denoising, and the computing process for denoising
$${x}_{t}^{final}$$
is as follows: first, calculating the iteration number step-value required for traversing, wherein the values of the step-value are k, k−1, . . . 1; and then performing step, step-1 . . . 1, 0 reverse processes on the gridded data according to different iteration number step-values to obtain the denoised data.

2. The method for gridding and denoising of geophysical potential field data according to claim 1, wherein step 1 comprises:
step 1.1: generating an original geophysical potential field data set by means of stochastic forward modeling, wherein
the stochastic forward modeling is carried out to stochastically generate a cuboid model with different scales, different shapes, different positions, different densities and different magnetic susceptibility in a determined survey area space, and potential field anomaly data of the model is computed to form the original geophysical potential field data set, and
step 1.2: extracting a certain proportion of the geophysical potential field data and adding different levels of noise to generate the noisy data set of the geophysical potential field, wherein
a proportion of the extracted data is at least 1% of data in the original geophysical potential field data set, an amount of data for each type is the same, an amount of different component data used and an amount of different anomaly data used are the same, and the added noise is Gaussian noise.

3. The method for gridding and denoising of geophysical potential field data according to claim 2, wherein the potential field anomaly data includes gravity anomaly data, gravity gradient data, and magnetic anomaly and magnetic gradient type data, and the original geophysical potential field data set consists of various types of potential field anomaly data, wherein each set of the potential field anomaly data denotes an anomaly generated by a certain stochastic model.

4. The method for gridding and denoising of geophysical potential field data according to claim 2, wherein step 2 is implemented by training the diffusion model using a normalized original geophysical potential field data set, wherein a computing process of the diffusion model comprises a forward process and a reverse process.

5. The method for gridding and denoising of geophysical potential field data according to claim 4, wherein step 3 comprises:
step 3.1: calculating mean square error (MSE) values between denoised data and a noise-free original geophysical potential field data;
step 3.2: based on the MSE values between the denoised data and the noise-free original geophysical potential field data in step 3.1, obtaining the number of denoising steps corresponding to each noisy data set using the diffusion model trained in step 2; and
step 3.3: inputting the number of denoising steps obtained in step 3.2 and the corresponding noisy data set into the noise level selection network for training.

6. The method for gridding and denoising of geophysical potential field data according to claim 5, wherein step 3.2 comprises:
letting an iteration number be k, wherein k=0, 1, 2, . . . , kₘₐₓ, kₘₐₓ denotes a maximum iteration number, computing and recording the MSE values in a k-th iteration of the noisy data set, wherein the MSE values decrease as the iteration number increases, and if the MSE values increase, a number of reverse-process computations is a current iteration number k minus 1, and the number of de-noising steps is k−1.

7. The method for gridding and denoising of geophysical potential field data according to claim 6, wherein step 3.3 is implemented by normalizing the noisy data set, and using a classification network model as the noise level selection network, wherein the classification network model uses cross-entropy as a loss function.

8. The method for gridding and denoising of geophysical potential field data according to claim 7, wherein step 4 comprises:
step 4.1: determining observation and survey-line spacing of the scattered point data according to the geophysical potential field data to be processed, and determining a spatial distribution range of the scattered point data; and
step 4.2: calculating a Euclidean distance between positions of geophysical potential field data points to be processed and positions of points of the scattered point data, and assigning positions of designated scattered points according to the Euclidean distance, wherein traversing coordinates of the geophysical potential field data points to be processed, and assigning the geophysical potential field data to be processed to corresponding positions in the scattered point data according to a corresponding minimum Euclidean distance to obtain the scattered point data, wherein the scattered point data comprises data coordinates and corresponding potential field data.

9. (canceled)

10. (canceled)
